(19) United States
(12) Patent Application Publication
(10) Pub. No.: US 2025/0297105 A1
(43) Pub. Date: Sep. 25, 2025

(54) SOFT WASTE PLASTIC-MODIFIED ADDITIVE

(71) Applicant: The Curators of the University of Missouri, Columbia, MO (US)

(72) Inventors: William G. Buttlar, Columbia, MO (US); Helmut Leodarta, Columbia, MO (US)

(21) Appl. No.: 19/086,440

(22) Filed: Mar. 21, 2025

Related U.S. Application Data
(60) Provisional application No. 63/568,133, filed on Mar. 21, 2024.

(51) Int. Cl. C08L 95/00; C08K 5/04; C08K 11/00

(52) U.S. Cl. CPC C08L 95/00; C08K 5/04; C08K 11/00; C08L 2555/80

(57) ABSTRACT

A softened plastic additive, wherein the additive comprises a predetermined quantity of a plastic material and a quantity of a bio-based oil that is heated and mixed with the plastic material to provide a melted plastic and bio-based oil mixture. The quantity of the bio-based oil is determined based on the predetermined quantity of the plastic material.

### CROSS-REFERENCE TO RELATED APPLICATIONS

This application claims the benefit of U.S. Provisional Application No. 63/568,133, filed on Mar. 21, 2024. The disclosure of the above application is incorporated herein by reference in its entirety.

### FIELD

The present teachings relate to a softened plastic additive that can be mixed with asphalt or polymer-modified materials to produce more durable final produce.

### BACKGROUND

The statements in this section merely provide background information related to the present disclosure and may not constitute prior art.

Plastic-modified asphalt has emerged as a popular research field within the larger context of environmental sustainability and increased utilization of waste materials in asphalt mixes. Potential economic savings is also an attractive factor, as plastic is a recycled material with stiffness and toughness attributes that suggest its potential to create longer-lasting pavements. The incorporation of plastic into asphalt can be done via wet or dry processes. The addition of plastic via the wet process would be expected to have storage stability issues, as plastic has a strong tendency to separate from a binder due to its lower density and its inert nature. Lately, multiple asphalt additives have been introduced as compatibilizers to address storage stability issues. The dry process would allow a more significant amount of plastic utilization, as storage stability and the ability to pump the resulting, highly viscous asphalt through pipes and pumps is avoided. However, the workability of mixtures containing a high amount of plastic could be a challenge. Once added into asphalt mixes, plastic does not fully melt, but rather stretches, creating a fibrous connectivity between aggregates when viewed using electron microscopy. Furthermore, mix performance test results showed that the addition of original waste plastic significantly improved rut resistance, but also lowered intermediate crack test scores.

More particularly, industries are increasingly adopting sustainable practices to achieve net-zero carbon emissions by 2050. The construction industry, responsible for 38% of global emissions, is a critical focus area for sustainability efforts. Within this sector, the asphalt paving industry is making strides by lowering production temperatures, incorporating recycled materials, and reducing reliance on virgin liquid asphalt. Initiatives like the Federal Buy Clean Initiative and the Low-Carbon Transportation Materials Program further incentivize the use of recycled content in asphalt mixes, driving sustainable innovation. Plastic-modified asphalt has emerged as a promising approach to addressing waste management and sustainability challenges by repurposing discarded plastics as additives. While the use of plastic in asphalt enhances durability and resistance to heavy loads and high temperatures, the reliance on hard plastic often leads to workability and cracking issues.

Most existing asphalt additives, such as rubber and conventional plastic, are primarily designed to stiffen asphalt, improving its ability to withstand high temperatures during hot summer conditions. However, excessive stiffening often results in pavement brittleness, which reduces fatigue resistance under cyclic traffic loading and cold temperature crack resistance. Over time, these vulnerabilities lead to the development of severe cracks in the pavement structure that compromise safety and ride comfort, deteriorate structural capacity, and increase maintenance costs. Addressing these durability challenges typically requires multiple additives, which increases costs and complicates material selection and production operations for contractors and owner-agencies.

Additionally, the presence of PFAS (per- and polyfluoroalkyl substances) in plastic materials has raised concerns about their potential environmental and health impacts. Commonly known as “forever chemicals,” PFAS are highly persistent in the environment and have been linked to serious health issues such as cancer, liver damage, and developmental problems. These substances are often associated with plastic products that are used for their water-repellent and non-stick properties. The presence of PFAS in construction materials can lead to long-term environmental contamination and pose public health risks.

Currently available asphalt additives fail to provide a comprehensive “triple-bottom-line” value, i.e., delivering high performance, sustainability, and affordability. Public agencies predominantly rely on low-bid scoring systems for selecting contractors and material designs for highway and airfield paving projects, emphasizing cost over environmental considerations. While environmental factors, encouraged by the EPA, are gradually influencing procurement decisions, they remain secondary and depend heavily on Environmental Product Declarations (EPDs) to quantify sustainability benefits. A more balanced approach to pavement material procurement involving EPDs is expected to evolve over the next decade, which will drive up demand for less carbon-intensive materials, particularly those containing recycled materials. Thus, there is a critical need for new, innovative asphalt materials that balance performance, cost, and sustainability to address evolving industry and regulatory trends.

### SUMMARY

The present disclosure addresses the pressing need to create a contractor-friendly additive that addresses the critical problem of over-stiffening and embrittlement of modern asphalt mixtures due to multiple, high levels of recyclates being used. To mitigate both workability deficiencies and lack of crack resistance barriers, the present disclosure provides a tailored softened, plasticized, waste plastic additive for asphalt paving mixtures. In various embodiments, a bio-based oil is heated and mixed with waste plastic creating a softened plastic substance or material. Importantly, the softened plastic substance/material provides a softened plastic base or additive to mix with asphalt. The softened plastic base/additive melts at lower temperatures the is required for known processes of mixing raw waste plastic with the asphalt and additionally better coats the asphalt aggregates. This is a key consideration as the pavement industry moves towards its Net Zero carbon emissions goal in the coming years; asphalt production temperatures are expected to be required to decrease significantly, posing challenges for higher viscosity asphalt additives.

The softened plastic base/additive of the present disclosure also possesses a more rubbery consistency than regular post-consumer recycled plastic. Programs such as the Federal Buy Clean Initiative and Low-Carbon Transportation Materials Program are promoting the use of multiple recycled material sources in asphalt mixes; The softened plastic base/additive of the present disclosure can be formulated using a mixture of one or more additional recycled material components. For instance, recycled ground tire rubber (GTR) can be used in addition to waste plastic, which has shown to produce the softened plastic base/additive having favorable crack and rutting resistance properties. In various instances, the softened plastic base/additive can be mixed or combined with unmodified waste plastic, thereby producing a hybrid softened plastic base/additive that has been shown to exhibit significantly higher rut and crack resistance than known asphalt mixtures. Furthermore, volumetric analysis has shown that the presence of the softened plastic base/additive of the present disclosure in an asphalt mixture significantly reduces the amount of virgin binder needed, which opens the door for significant cost-savings potential and another means to meet Net Zero requirements. Another potential benefit of the softened plastic base/additive of the present disclosure would be as an aid to help asphalt mix designers meet modern balanced mix design (BMD) performance requirements, especially when a high reclaimed asphalt pavement (RAP) content is desired. The softened plastic base/additive can also assist designers to incorporate recycled asphalt shingles (RAS) in their asphalt mixture designs, while meeting modern balanced mixture design cracking test requirements despite. By tailoring the stiffness of the softened plastic base/additive, higher proportions of RAP and RAS recyclates can be attained while ensuring pavement durability by meeting strict balanced mix design requirements.

The softened plastic base/additive of the present disclosure provides a product that contractors can use to soften asphalt mixes, which is necessary in the new advent of balanced mix design practices, which are evolving across the US. The softened plastic base/additive also helps to increase the sustainability and resilience of asphalt mixtures, while also helping to increase the amount of other recyclates that can be simultaneously used (e.g., RAP, RAS, GTR). Furthermore, the process of producing or manufacturing the softened plastic base/additive insures that the softened plastic base/additive is free of per- and polyfluoroalkyl substances (PFAS), which are known to persist in the environment and cause serious health risks. The process ensures that no PFAS is introduced at any stage of the creation of the softened plastic base/additive, promoting a sustainable, high-performance, and environmentally responsible material for asphalt mixtures.

This tailored softened plastic base/additive of the present disclosure can be customized with ground tire rubber or unsoftened plastic, thereby providing a hybrid softened plastic base/additive that offers exceptional crack and deformation resistance while significantly reducing the need for expensive and carbon-intensive virgin binders. By lowering the demand for virgin liquid asphalt, softened plastic base/additive and the hybrid softened plastic base/additive lead to cost savings, making contractors more competitive in low-bid project environments. Research has found that the melt point of many prevalent waste plastic streams is generally too high for optimized use in the application of an asphalt additive (added by the contractor directly to the asphalt mix plant). However, the softened plastic base/additive disclosed herein lowers the melting point of the plastics by precise use of heat, mixing, and optionally, heating under pressure. This softened plastic base/additive comprising post-consumer recycled (PCR) or virgin plastic and/or ground tire rubber (GTR) softened with bio-based oil can be used to balance/lower the stiffness of otherwise brittle asphalt mixtures and can be used in both the wet and dry process of asphalt blending.

Additionally, research has also found that the hybrid softened plastic base/additive, comprising the softened plastic base/additive mixed with unmelted original (non-softened) PCR waste or virgin plastic and/or ground tire rubber (GTR), is a very effective asphalt additive for use by contractors in creating modern, balanced asphalt mix designs, while boosting recycling content and mixture sustainability. The use of high amounts of polymeric additives also toughens the asphalt mixture, rendering it more resilient to extreme weather events (extreme temperatures, large temperature swings, and extreme moisture conditions), along with preventing the damage that can otherwise result in the event of traffic overload events. The hybrid softened plastic base/additive is highly innovative in that it contains mixed viscosity and toughness elements, where the low viscosity imparted by the portion of the hybrid softened plastic base/additive consisting of the softened plastic base product lowers the amount of effort and energy required to mix the asphalt with aggregate, while boosting cracking test scores in balanced mix design. The unmelted non-softened plastic and/or GTR portion of the hybrid product completes the two-phase composite material. The non-softened waste or virgin plastic portion creates a fibrous network of polymers (as verified through electron microscopy) after heating and mixing of the asphalt mixture, which imparts both high temperature rutting resistance in the mixture while usually also helping to boost cracking test scores. When GTR is used as a non-softened portion of the additive, crack resistance is boosted by virtue of the crack pinning characteristics of the GTR. Rutting resistance is usually also boosted by the incorporation of GTR in the additive, owing to the high toughness and high elasticity of recycled tire rubber.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### BRIEF DESCRIPTION OF DRAWINGS

The drawings described herein are for illustration purposes only and are not intended to limit the scope of the present teachings in any way.

FIG. 1 is an exemplary block diagram final product (e.g., an asphalt mixture or polymer-modified material) comprising a softened plastic composition that serves as a base or additive that can be added to other target materials such as asphalt mixtures and polymer-modified materials, in accordance with various embodiments of the present disclosure.

FIG. 2 is an exemplary block diagram of the final product comprising a formulation of the softened plastic base or additive shown in FIG. 1, in accordance with various embodiments of the present disclosure.

FIG. 3 is an exemplary block diagram of the final product comprising another formulation of the softened plastic base or additive shown in FIG. 1, in accordance with various other embodiments of the present disclosure.

FIG. 4 is an exemplary block diagram of the final product comprising yet another formulation of the softened plastic base or additive shown in Figure, in accordance with yet other embodiments of the present disclosure.

FIG. 5 is an exemplary block diagram the final product comprising a hybrid formulation of the softened plastic base or additive shown in FIG. 1, in accordance with yet other embodiments of the present disclosure.

FIG. 6, exemplarily illustrates various examples of formulations of the softened plastic base/additive shown in FIG. 1 and the optimal processing thereof, in accordance with various embodiments of the present disclosure.

FIG. 7, exemplarily illustrates various examples of formulations of the hybrid softened plastic base/additive shown in FIG. 5 and the optimal processing thereof in, accordance with various embodiments of the present disclosure.

FIG. 8 exemplarily illustrates the performance of asphalt mixtures against thermal cracking and deformation, in accordance with various embodiments of the present disclosure.

FIG. 9 exemplarily illustrates the performance of asphalt mixtures against thermal and fatigue cracking, in accordance with various embodiments of the present disclosure.

FIG. 10 exemplarily illustrates the performance of asphalt mixtures against fatigue cracking and deformation, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

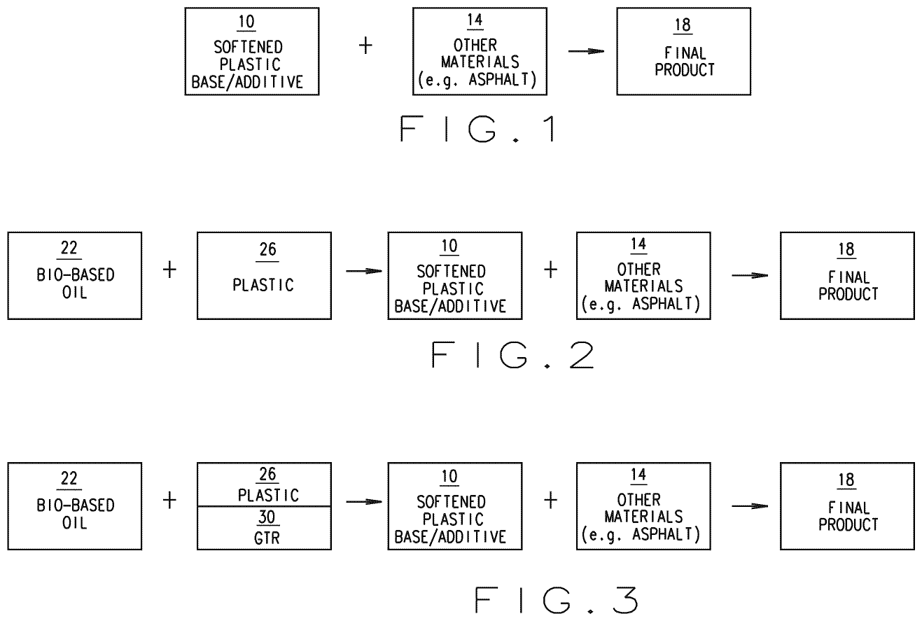

Referring to FIG. 1, generally, the present disclosure provides a softened plastic composition 10 that can be used as a base or additive that can be added to other target materials 14 such as asphalt mixtures (e.g., aggregates and an asphalt binder) and various polymer-modified materials, to improve various physical characteristics of the resulting final product 18 (e.g., the mechanical strength, workability, durability, resilience and resistance to environmental degradation), making the softened plastic base/additive 10 suitable for use in infrastructure, industrial, and consumer products. The softened plastic composition 10 is often referred to herein as the softened plastic base/additive 10. The softened plastic base/additive 10 also reduces the temperature needed to manufacture or produce the final product 18 and thereby reduces the carbon footprint of manufacturing or producing the final product 18.

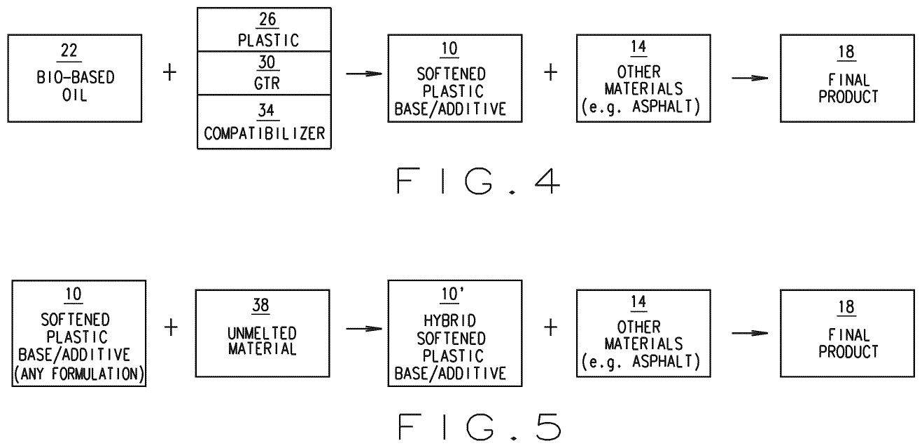

Referring now to FIGS. 1 and 2, in various embodiments, the softened plastic base/additive 10 comprises a quantity or amount of bio-based oil 22 mixed or blended with a quantity or amount of plastic 26 at a particular ratio of bio-based oil 22 to plastic 26. The plastic 26 can be any suitable kind, type or composition of plastic that will melt and homogenously mix or blend with the bio-based oil 22 when the bio-based oil 22 is heated to temperature needed to melt the respective plastic 26. For example, the plastic 26 can be waste plastic, recycled plastic, virgin plastic (e.g., unused plastic), scrap plastic, etc. In such embodiments, to manufacture or produce the softened plastic base/additive 10 the bio-based oil 22 and plastic 26 mix is heated to a temperature where the plastic 26 melts, for example 90° C.-300° C., e.g., 150°−170° C. The melted bio-based oil 22 plus plastic 26 mixture is homogenously mixed or blended and then allowed to solidify, whereafter the solidified homogenously blended bio-based oil 22 and plastic 26 mix (i.e., the softened plastic base/additive 10) can be shredded into shredded pieces or pelletized into pellets or turned into a resin formation that can then be packaged.

The ratio of bio-based oil 22 to plastic 26 is determined based on a softness of the softened plastic base/additive 10 needed to produce the final product 18 having the desired physical characteristics. For example, in various embodiments the ratio of bio-based oil 22 to plastic 26 can be expressed in percentage by weight of bio-based oil 22 to the plastic 26. For example, in various instances the softened plastic base/additive 10 can comprise the bio-based oil 22 in an amount ranging from 10% to 350% of the weight of the plastic 26, e.g., the softened plastic base/additive 10 can comprise the bio-based oil 22 in an amount ranging from 75% to 150% of the weight of the plastic 26, for instance the softened plastic base/additive 10 can comprise the bio-based oil 22 in an amount that is 100% of the weight of the plastic 26 (i.e., equal parts bio-based oil 22 and plastic 26).

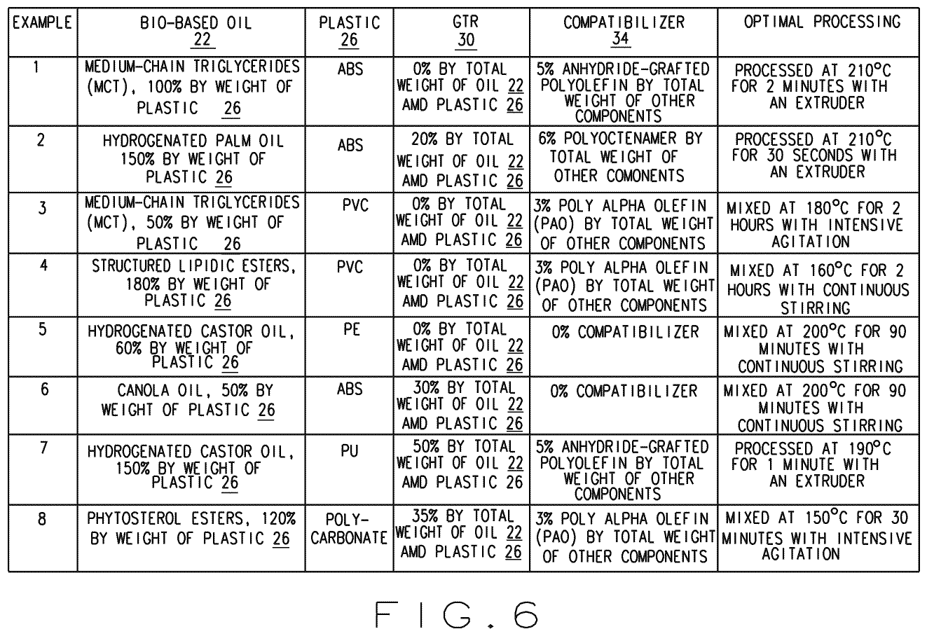

Referring now to FIGS. 1, 2 and 3 in various other embodiments, the softened plastic base/additive 10 can additionally include a quantity of ground tire rubber (GTR) 30. Specifically, in such embodiments, the softened plastic base/additive 10 can comprises a quantity of bio-based oil 22, a quantity of plastic 26 and a quantity of GTR 30. In various instances of such embodiments the quantity of ground tire rubber (GTR) 30 can be added to the bio-based oil 22 and plastic 26 mix. Particularly, the quantity of GTR 30 is added at a particular ratio of bio-based oil 22 and plastic 26 mix. For example, the ratio of GTR 30 to the bio-based oil 22 and plastic 26 mix can be expressed in percentage by weight of bio-based oil 22 plastic 26 mix. For example, in various instances the softened plastic base/additive 10 can comprise GTR 30 in an amount ranging from 1% to 100% of the cumulative weight of the bio-based oil 22 plus the plastic 26, e.g., the softened plastic base/additive 10 can comprise the GTR 30 in an amount ranging from 10% to 50% of the combined weight of the bio-based oil and plastic 26. In such embodiments, to manufacture or produce the softened plastic base/additive 10 the bio-based oil 22 and plastic 26 and GTR 30 mix is heated to a temperature where the plastic 26 and GTR 30 melt, for example 90° C.-300° C., e.g., 150°−170° C. The melted bio-based oil 22 plus plastic 26 plus GTR 30 mixture is homogenously mixed or blended and then allowed to solidify, whereafter the solidified homogenously blended bio-based oil 22, plastic 26 and GTR 30 mix (i.e., the softened plastic base/additive 10) can be shredded into shredded pieces or pelletized into pellets or turned into a resin formation that can then be packaged.

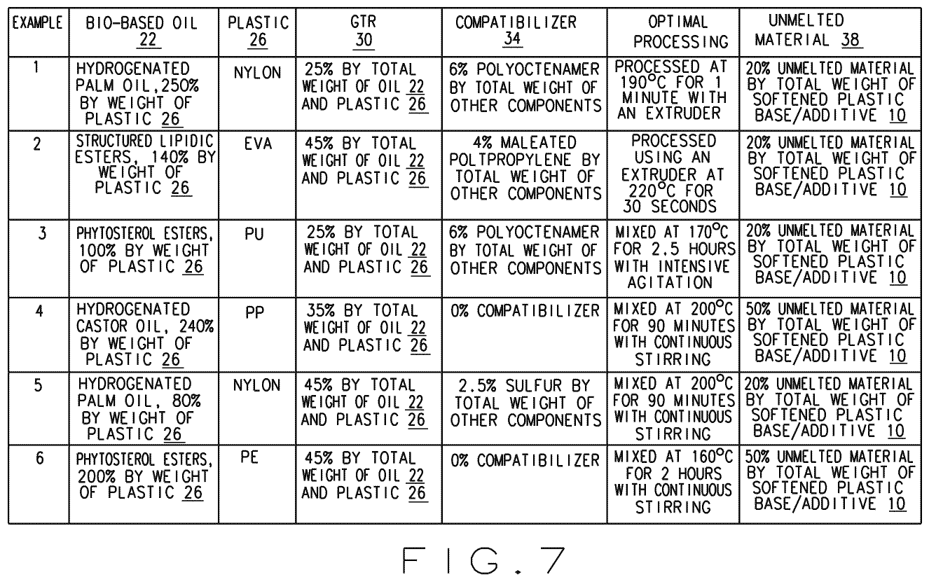

Referring now to FIGS. 1, 2, 3 and 4, in various embodiments, the softened plastic base/additive 10 can further include a compatibilizer 34 to prevent separation of components of the softened plastic base/additive 10 (e.g., prevent separation of the formulation comprising bio-based oil 22 and plastic 26, or prevent separation of the formulation comprising bio-based oil 22, plastic 26 and GTR 30) while the components are heated, melted and mixed or blended. In such embodiments, the compatibilizer 34 can be added at a particular ratio of the formulation of the other components of the softened plastic base/additive 10 (e.g., the formulation comprising bio-based oil 22 and plastic 26, or the formulation comprising bio-based oil 22, plastic 26 and GTR 30). For example, the ratio of compatibilizer 34 to the formulation of other components of the softened plastic base/additive 10 can be expressed in percentage by weight of compatibilizer 34 to the cumulative weight of the formulation other components. For example, in various instances the softened plastic base/additive 10 can comprise the compatibilizer 34 in an amount ranging from 1% to 20% of the cumulative weight of the formulation of other components of the softened plastic base/additive 10. In such embodiments, to manufacture or produce the softened plastic base/additive 10 the compatibilizer 34 plus the formulation of other components (e.g., the formulation comprising bio-based oil 22 and plastic 26, or the formulation comprising bio-based oil 22, plastic 26 and GTR 30) is heated to a temperature where the compatibilizer 34 and formulation other components melt, for example 90° C.-300° C., e.g., 150°-170° C. The melted mixture is homogenously mixed or blended and then allowed to solidify, whereafter the solidified homogenously blended compatiblizer 34 plus the formation of other components (i.e., the softened plastic base/additive 10) can be shredded into shredded pieces or pelletized into pellets or turned into a resin formation into pellets that can then be packaged.

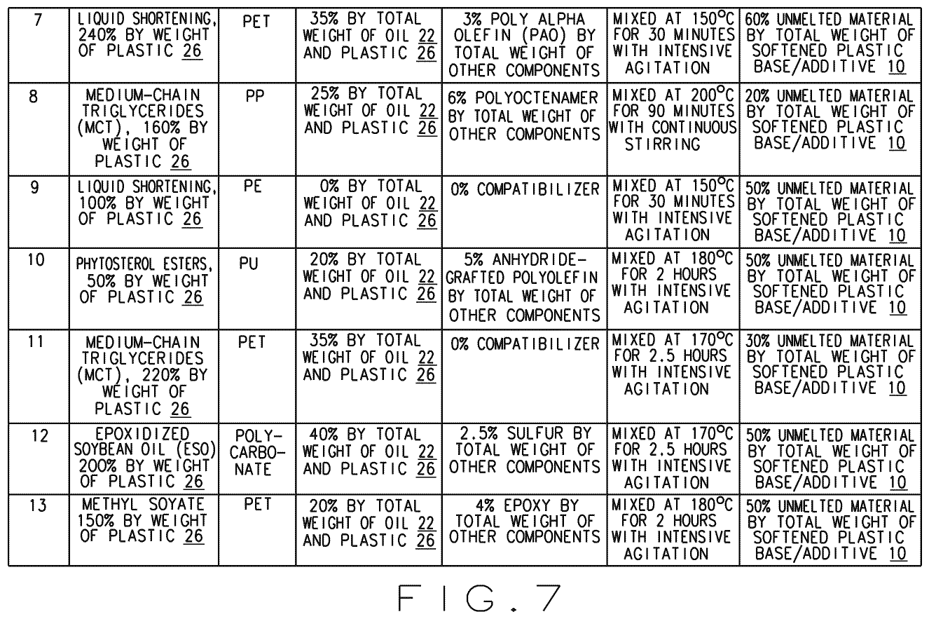

Referring now to FIGS. 1, 2, 3, 4 and 5, in various other embodiments, a hybrid softened plastic base/additive 10′ can be manufactured or produced, wherein the hybrid softened plastic base/additive 10′ comprises the softened plastic base/additive 10 plus a quantity of unmelted material 38 (e.g., original (non-softened) post-consumer recycled (PCR) waste and/or virgin plastic and/or GTR). More particularly, the hybrid softened plastic base/additive 10′ can comprise the shredded or pelletized or resin softened plastic base/additive 10 (as described above) combined and packaged with a predetermined quantity of the unmelted material 38 such as original (non-softened) post-consumer recycled (PCR) waste and/or virgin plastic and/or GTR. The hybrid softened plastic base/additive 10′ having the added unmelted material 38 provides a composite of hard and soft materials (e.g., the hard unmelted material 38 and the softened plastic additive/base 10), which when mixed with asphalt makes the resulting pavement very durable and versatile in all weather conditions-cold, hot, warm etc. The hybrid softened plastic base/additive 10′ has been found to be a very effective asphalt additive for use by contractors in creating modern, balanced asphalt mix designs, while boosting recycling content and mixture sustainability. The softened plastic base/additive 10 used to manufacture or produce the hybrid softened plastic base/additive 10′ can comprise either embodiment of the softened plastic base/additive 10 described above (e.g., the bio-based oil 22 plus the plastic 26 embodiment, or the bio-based oil 22 plus the plastic 26 plus GTR 30 embodiment).

The bio-based oil 22 can be any suitable bio-based oil. For example, in various embodiments the bio-based oil can be one or a combination of hydrophobic, lipophilic, and/or oleophilic bio-derived compounds, including but not limited to long-chain triglycerides, hydroxylated fatty acid esters, epoxidized lipid derivatives, and transesterified ester compounds. These compounds can include esterified unsaturated lipid fractions, ricinoleic acid derivatives, structured lipidic esters, hydroxylated triglyceride compounds, partially hydrogenated lipid blends, epoxidized fatty acid methyl esters (FAME), tocopherol-enriched fractions, sterol-based emulsifiers, phospholipid-based surfactants, as well as specific bio-based oils such as canola oil, castor oil, corn oil, linseed oil, palm oil, rapeseed oil, sunflower oil, soybean oil, avocado oil, coconut oil, peanut oil, liquid shortening, epoxidized soybean oil (ESO), hydrogenated castor oil, methyl soyate, hydroxylated rapeseed oil, hydrogenated palm oil, palm stearin, hydrogenated soybean oil, medium-chain triglycerides (MCT), alpha tocopherol concentrates, phytosterol esters, lecithin-derived phospholipids, and glyceryl monostearate. The bio-based 22 oil can be sourced from virgin or recycled sources, including but not limited to newly extracted oils, re-refined oils, or post-consumer and industrial waste oils.

The plastic 26 can be any suitable plastic. For example, in various embodiments the plastic 26 can be single or blended thermoplastic resins, that can be sourced from post-consumer recycled (PCR) plastic, virgin plastic, or a combination thereof. These resins include, but are not limited to, polyethylene (PE), polypropylene (PP), polyethylene terephthalate (PET), polyvinyl chloride (PVC), acrylonitrile butadiene styrene (ABS), nylon, polycarbonate, polyurethane (PU), and ethylene vinyl acetate (EVA).

The optional compatibilizer 34 can be any suitable compatibilizer. For example, in various embodiments the compatibilizer 34 can be one or a combination of chemically active dispersants, interfacial agents, and structural modifiers, including but not limited to maleated polypropylene, anhydride-grafted polyolefins, poly alpha olefin (PAO), polyphosphoric acid (PPA), paraffin wax, cellulose, lignin, montmorillonite, bentonite, zeolite, hydrated lime, fly ash, corn starch, lecithin, natural rubber, polyoctenamer, epoxy, sulfur, polyamide (PA), butylated hydroxyl toluene (BHT), tert-butylhydroquinone (TBHQ), alpha-tocopherol, thermoplastic elastomer-based dispersants, hydroxyl-functionalized polymers, amine-terminated polyolefins, organo-modified silicate clays, polymeric surfactants, phosphorylated oligomers, reactive resin blends, and compatibilizing copolymers containing polar functional groups.

In various embodiments, the manufacture or production of the Softened plastic base/additive 10, the homogenized mixed or blended formulation of components is processed through a controlled thermomechanical dispersion process. The bio-based oil 22 is initially combined with the plastic 26 and/or the GTR 30 creating a uniform product with a rubbery, flexible consistency. As described above, the optional compatibilizer 34 can be added to enhance interfacial adhesion for improved dispersion and compatibility. The formulation undergoes intensive agitation via a mixer or similar equipment, which can include, but is not limited to, an extruder. In various embodiments, the formulation can be processed exclusively using an extruder, or alternatively, the manufacturing or production process can involve a combination of both mixing and extruder-based agitation to achieve the desired level of molecular integration and uniformity. As described above, the formulation is subjected to precisely controlled thermal conditions ranging from 90° C. to 300° C., e.g., 150°−170° C. to facilitate molecular integration. The heating and mixing process also serves to degrade any PFAS that may be contained within the plastic, further ensuring that the resulting softened plastic base/additive 10 is free of PFAS contamination. The agitation is performed until uniformity is reached, with the constant mixing process continuing for a period ranging from approximately 5 seconds to 10 hours, depending on the specific formulation, desired characteristics of the softened plastic base/additive 10 and the mixing method used. Alternatively, the optional compatibilizer 34 can be introduced after the bio-based oil 22 has been mixed with plastic 26 and/or the GTR 30. The resulting homogeneous mixture of the softened plastic base/additive 10 is then subjected to mechanical refinement, which as described above can include shredding, pelletization, or resin formation to optimize its compatibility and dispersibility within asphalt or polymer-modified materials as a functional additive.

As described above, the softened plastic base/additive 10 can be used as an additive for asphalt mixtures, including warm mix and cold mix asphalt formulations, and contributes to improved mechanical strength, flexibility, and resistance to environmental degradation when used in polymer-modified asphalt formulations. The softened plastic base/additive 10 provides both flexible and rigid properties, which increases asphalt mixture durability against rutting by reducing rut depth. Additionally, the softened plastic base/additive 10 enhances durability against cracking, achieving higher scores in cracking tests such as the CT index and DCT fracture energy tests, though it is not limited to these specific tests and can be evaluated using other performance tests to assess mechanical improvements. For example, an asphalt mixture can be made comprising virgin aggregates, an asphalt binder and the softened plastic base/additive 10. For instance, an asphalt mixture can be made comprising 18% to 98.9% of virgin aggregates, 0.1% to 10% of an asphalt binder and 0.1% to 20% of the softened plastic base/additive 10. Or, for example, an asphalt mixture can be made comprising virgin aggregates, an asphalt binder and the hybrid softened plastic base/additive 10′. For instance, an asphalt mixture can be made comprising 18% to 98.9% of virgin aggregates, 0.1% to 10% of an asphalt binder and 0.1% to 20% and 0.1% to 90% of the hybrid softened plastic base/additive 10′, which can exemplarily comprise 0.1% to 20% of the softened plastic base/additive 10 plus 0% to 80% reclaimed asphalt pavement (RAP) and/or 0% to 50% reclaimed asphalt shingles (RAS).

In various embodiments, the softened plastic base/additive 10 (e.g., the formulation comprising bio-based oil 22 and plastic 26, or the formulation comprising bio-based oil 22, plastic 26 and GTR 30) and the hybrid softened plastic base/additive 10′ can be incorporated into asphalt binder at ratios between 1:20 and 20:1 by weight the softened plastic base/additive 10 to the asphalt binder for use as an adhesive, road crack filler, sealant, roofing material, structural reinforcement material, or a moldable polymer formulation including adhesives for pavement joints, road crack fillers, sealants for expansion joints, pothole patching compounds, cold patch repair materials, anti-rutting modifiers, modified asphalt for airport runways, waterproof underlayments for road foundations, roofing membrane reinforcements, weather-resistant roofing tiles, waterproof foundation coatings, prefabricated expansion joints, composite bridge decking, durable paver blocks, flexible curb components, modular road panels, permeable pavement elements, chemical-resistant flooring, impact-resistant padding, corrosion-resistant pipeline coatings, abrasion-resistant coatings for machinery, waterproof concrete coatings, chemical-resistant storage tank coatings, anti-slip factory flooring, marine structure coatings, railway and bridge deck coatings, vibration-dampening machinery coatings, impact-resistant military coatings, underground utility pipeline coatings, weatherproof electrical enclosures, sealing coatings for wastewater treatment facilities and airport runways, underbody protective coatings for vehicles, wheel well liners for impact resistance, flexible sound-dampening panels for vehicle interiors, heavy-duty truck bed liners for surface protection, and durable splash guards and mud flaps. When not combined with asphalt binder, the softened plastic base/additive 10 can also be utilized as a moldable plastic for applications including durable consumer goods, which can include flexible shoe soles, weather-resistant outdoor furniture, shock-absorbing phone and laptop cases, sports equipment grips, reusable containers, impact-resistant protective gear, vibration-dampening mats, heavy-duty tool casings, eco-friendly food packaging, and high-resilience yoga, exercise mats, 3D printing material, and hot-melt adhesive. In building construction environments, the softened plastic base/additive 10 can also be used for pre-fabricated expansion joints, impact-resistant wall panels, industrial flooring, insulating panels, reinforced structural materials, waterproof siding, safety barriers, flexible conduits, seismic-resistant reinforcements, and lightweight roofing panels. Automotive applications of the softened plastic base/additive 10 can include shock-absorbing bumper inserts, wheel well liners, underbody protective covers, trunk liners, soundproofing panels, vibration-dampening engine mounts, heat-resistant gaskets, truck bed liners, splash guards, and flexible dashboard components. In industrial settings, the softened plastic base/additive 10 can also be used for wear-resistant conveyor belt components, vibration-dampening machine pads, safety flooring, corrosion-resistant storage tank linings, abrasion-resistant machinery covers, warehouse protective padding, heavy-duty cable insulation, noise-reducing panels, impact-resistant packaging, and reinforced polymer casings for machinery.

The softened plastic base/additive 10 and the hybrid softened plastic base/additive 10′ as described herein provide a versatile, environmentally sustainable, and performance-enhancing solution suitable for a wide range of industrial and infrastructure applications. The softened plastic base/additive 10 leverages the benefits of bio-based oils and recycled materials to deliver improved mechanical properties, such as enhanced flexibility and resistance to environmental degradation. Due to its utilization of recycled materials, including waste plastic and GTR, the softened plastic base/additive 10 facilitates the increased inclusion of reclaimed materials such as reclaimed asphalt pavement (RAP) and reclaimed asphalt shingles (RAS), thereby reducing the need for virgin binder. Furthermore, the adaptability of the softened plastic base/additive 10 for use in both warm mix and cold mix asphalt applications results in a lower carbon footprint for asphalt pavement, contributing significantly to the development of more sustainable infrastructure. It should be noted that while RAP and RAS are not used to formulate the softened plastic base/additive 10, the softened waste plastic additive 10 opens the door for increasing the proportion of these other recycled materials in a given mixture. This in turn renders the subsequent mixtures as even more economical and sustainable.

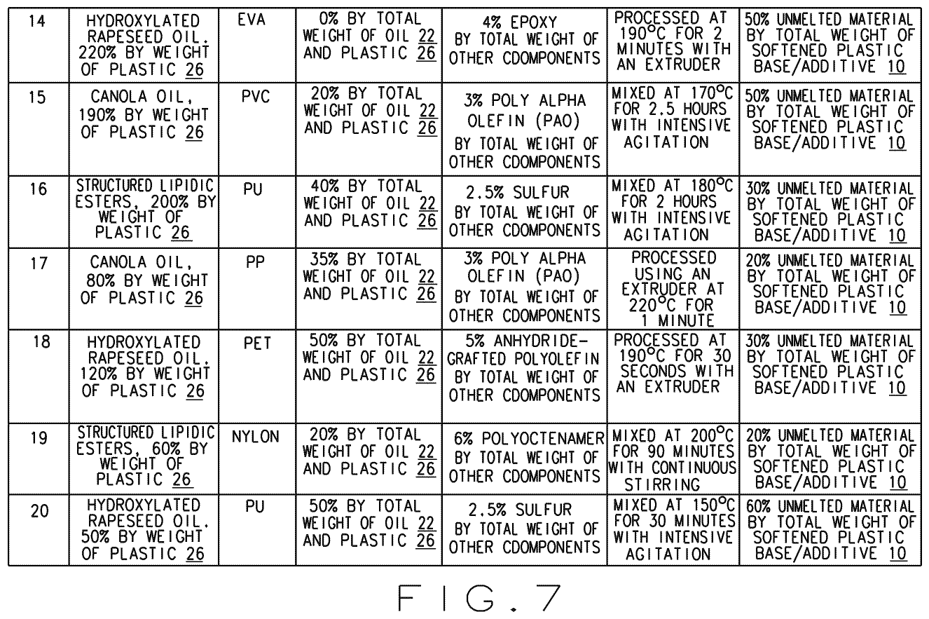

Referring now to FIG. 6, various examples of formulations of the softened plastic base/additive 10 comprising the bio-based oil 22 and the plastic 26 and optionally the GTR 30 and/or the compatibilizer 34, and the optimal processing are shown in FIG. 6. Possible formulations of the softened plastic base/additive 10 and the processing thereof are not limited to the examples shown in FIG. 6.

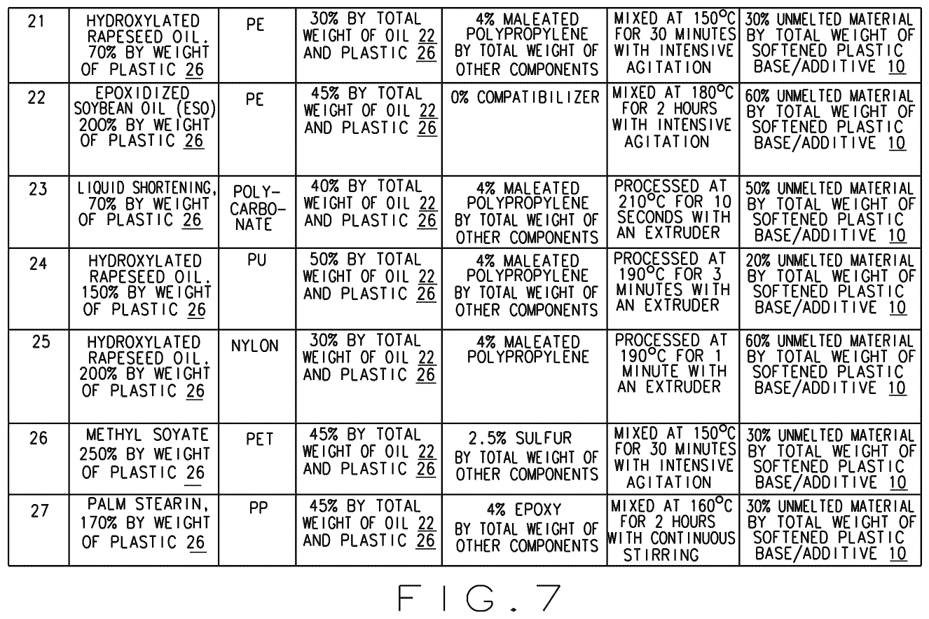

Referring now to FIG. 7, various examples of formulations of the hybrid softened plastic base/additive 10′ comprising the softened plastic base/additive 10 (any formulation) and the optimal processing thereof, plus the unmelted material 38 are shown in FIG. 7. Possible formulations of the hybrid softened plastic base/additive 10′ are not limited to the examples shown in FIG. 7.

### Test and Test Results

As described above, softened plastic base/additive 10 of the present disclosure can be an asphalt modifier that consists of plastics 26, bio-based oil 22, and optional GTR 30. Asphalt pavements are increasingly adopting the so-called “Balanced Mix Design” (BMD), which emphasizes the balance of asphalt mixture performance in response to extreme traffic and climate challenges. Three commonly used design and quality control (QC) tests for rutting in the BMD approach were performed to evaluate and analyze the performance at high, intermediate, and low temperatures of asphalt mixed with the softened plastic base/additive 10 described. These tests were: 1) the IDEAL CT test, conducted in accordance with ASTM D8225, assesses intermediate-temperature fatigue cracking. The outcome of the IDEAL CT test is referred to as the CT-Index. A higher CT index indicates greater resistance to fatigue cracking; 2) the Hamburg Wheel Track test follows AASHTO T324 for evaluating high-temperature deformation (rutting). The outcome of this test is termed Rut Depth, measured in millimeters (mm). A lower rut depth signifies a higher resistance to deformation; and 3) the DCT test, performed according to ASTM D7313, evaluates the potential for low-temperature or thermal cracking. The result of the DCT test is called Fracture Energy, reported in Joules per square meter (J/m²). A higher fracture energy indicates greater resistance to thermal cracking. The asphalt mixture iterations examined were designed for typical city traffic conditions. The BMD performance specifications for asphalt mixtures designed for city traffic are as follows: 1) minimum 450 J/m² fracture energy in DCT test—Illinois Tollway (dense graded mixture, strictest requirement); 2) maximum 12.5 mm rut depth in Hamburg test—Illinois DOT, Missouri DOT; and 3) minimum 50 CT-Index in IDEAL CT test—Missouri DOT.

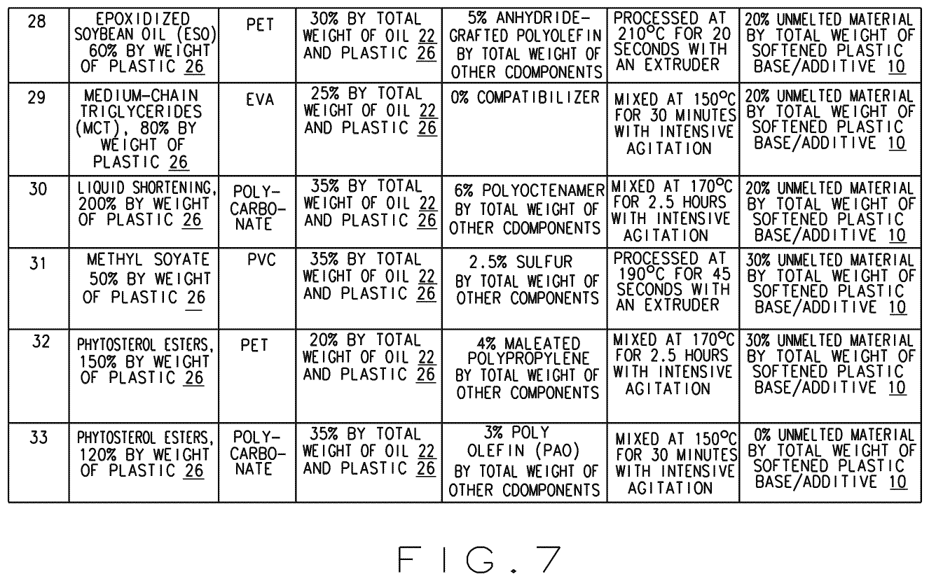

The performance results of the asphalt mixed with the softened plastic base/additive 10 are presented in Table 1 and FIGS. 8, 9 and 10.

TABLE 1
Performance Results of Asphalt Mixed With
Softened Plastic Base/Additive 10 & With
Hybrid Softened Plastic Base/Additive 10′

| | | Performance Results Average | | | |
|---|---|---|---|---|---|
| | % | DCT | | | |
| | Asphalt | Fracture | Hamburg | | |
| | Binder | Energy | Rut Depth | | CT |
| Mix | Required | (J/m²) | (mm) | #Passes | Index |
| Control (PG 64- | 4.80% | 340 | 20 | 10,333 | 103 |
| 22) | | | | | |
| Plastic | 4.50% | 336 | 6 | 20,000 | 36 |
| Softened Plastic | 3.80% | 1028 | 20 | 12,967 | 61 |
| Base/Additive 10 | | | | | |
| Hybrid Softened | 4.10% | 885 | 5 | 20,000 | 92 |
| Plastic | | | | | |
| Base/Additive 10′ | | | | | |

Referring to Table 1, the addition of the softened plastic base/additive 10 significantly reduced the required amount of asphalt binder to create an asphalt mixture compared to plastic, thereby reducing the production costs due to the high cost of asphalt binder. Individually, plastic and softened plastic base/additive 10 had contrasting effects on the performance of the asphalt mixture. Plastic increased the stiffness of the asphalt mixture, thereby improving its durability against deformation at high temperatures but displayed poor resistance against thermal cracking. Consequently, the test results show that plastic is more suitable for use in hotter climates. Conversely, the softened plastic base/additive 10 made the asphalt mixture softer, thus enhancing its resistance against thermal cracking but reducing its deformation durability. Therefore, the softened plastic base/additive 10 is better suited for colder climate areas. Individually, neither plastic nor the softened plastic base/additive 10 improved resistance against fatigue cracking. Typically, resistance against fatigue cracking improves with an increased asphalt binder content in the mixture, leading to higher production costs.

However, when combined in the asphalt mixture, the hybrid softened plastic base/additive 10′ demonstrated superior performance in resistance against fatigue cracking and deformation compared to when they were used individually. The hybrid softened plastic base/additive 10′ can help asphalt to meet the asphalt BMD performance specifications set by state agencies and also reduce the required amount of asphalt binder.

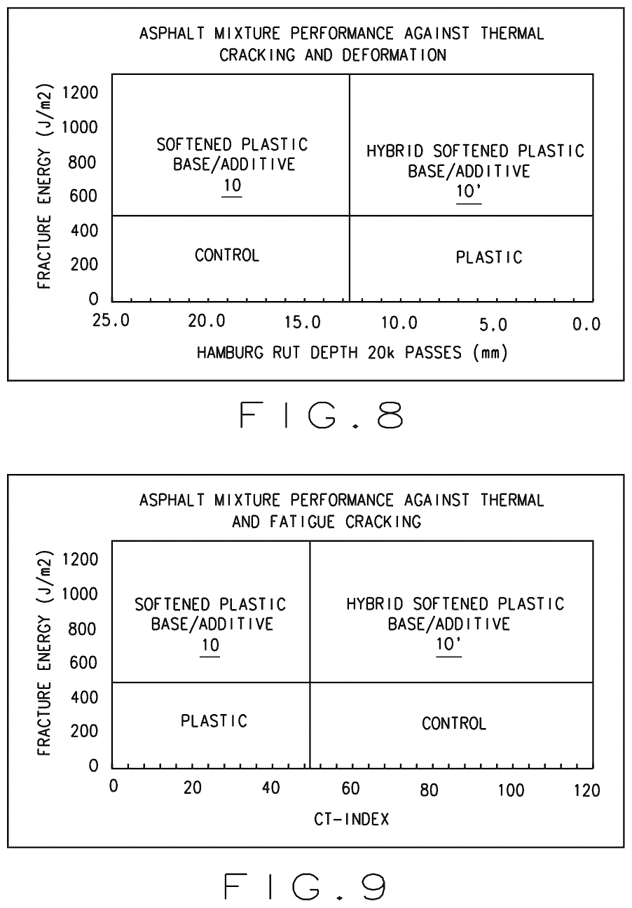

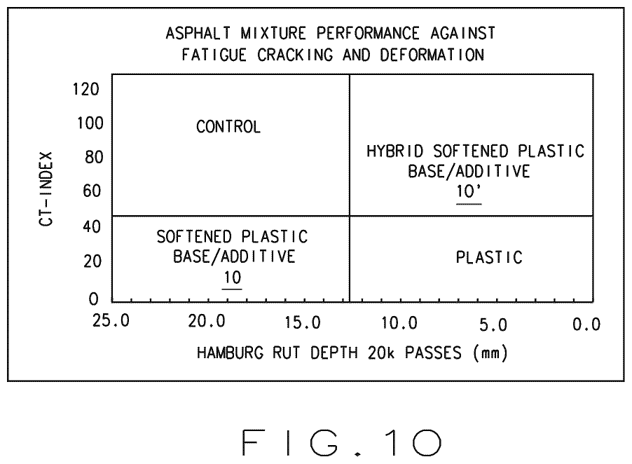

FIGS. 8, 9 and 10 illustrate the performance of the asphalt formulations in diagrams. FIG. 8 exemplarily illustrates the performance of asphalt mixtures against thermal cracking and deformation, in accordance with various embodiments of the present disclosure. FIG. 9 exemplarily illustrates the performance of asphalt mixtures against thermal and fatigue cracking, in accordance with various embodiments of the present disclosure. FIG. 10 exemplarily illustrates the performance of asphalt mixtures against fatigue cracking and deformation, in accordance with various embodiments of the present disclosure. The asphalt formulation is shown in the upper right corner of the diagrams, indicating high resistance against thermal cracking, deformation, and fatigue cracking. The hybrid softened plastic base/additive 10′ asphalt formulation consistently appears in the upper right corner of each diagram, suggesting that the hybrid softened plastic base/additive 10′ asphalt formulation can be effectively utilized in any area, regardless of climate temperature.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A softened plastic additive, said additive comprising:
a predetermined quantity of a plastic material; and
a quantity of a bio-based oil that is heated and mixed with the plastic material to provide a melted plastic and bio-based oil mixture, the quantity of the bio-based oil is determined based on the predetermined quantity of the plastic material.

2. The additive of claim 1 further comprising a quantity of unmelted material, the quantity of the unmelted material is determined based on the combined quantity of the plastic material and the bio-based oil.

3. The additive of claim 1 further comprising a quantity of a compatibilizer that is mixed with the mixed heated plastic and bio-based oil to provide a melted plastic, bio-based oil and compatibilizer mixture, the quantity of compatibilizer based on the combined quantity of the plastic material and bio-based oil.

4. The additive of claim 3 further comprising a quantity of unmelted material, the quantity of the unmelted material is determined based on the combined quantity of the plastic material, the bio-based oil and the compatibilizer.

5. The additive of claim 1 further comprising a quantity of ground tire rubber that is heated and mixed with the bio-based oil and the plastic material to provide a melted plastic, bio-based oil and ground tire rubber mixture, the quantity of ground tire rubber is determined based on the combined quantity of the plastic material and bio-based oil.

6. The additive of claim 5 further comprising a quantity of unmelted material, the quantity of the unmelted material is determined based on the combined quantity of the plastic material, the bio-based oil and the ground tire rubber.

7. The additive of claim 1 further comprising:
a quantity of ground tire rubber that is heated and mixed with the bio-based oil and the plastic material to provide a melted plastic, bio-based oil and ground tire rubber mixture, the quantity of ground tire rubber is determined based on the combined quantity of the plastic material and bio-based oil; and
a quantity of a compatibilizer that is mixed with the mixed heated plastic, bio-based oil and ground tire rubber to provide a melted plastic, bio-based oil and compatibilizer mixture, the quantity of compatibilizer based on the combined quantity of the plastic material and bio-based oil.

8. The additive of claim 7 further comprising a quantity of unmelted material, the quantity of the unmelted material is determined based on the combined quantity of the plastic material, the bio-based oil, the ground tire rubber and the compatibilizer.

9. The additive of claim 1, wherein the melted plastic and bio-based oil mixture is solidified to provide the solidified composition that can be one of shredded into shredded pieces or pelletized into pellets or turned into a resin formation to provide one of:
a shredded softened plastic additive;
a pelletized softened plastic additive; and
a resin softened plastic additive.

10. An asphalt mixture, said asphalt mixture comprising:
a virgin aggregates;
an asphalt binder; and
a softened plastic additive, wherein the softened plastic additive comprises:
a predetermined quantity of a plastic material; and
a quantity of a bio-based oil that is heated and mixed with the plastic material to provide a melted plastic and bio-based oil mixture, the quantity of the bio-based oil is determined based on the predetermined quantity of the plastic material.

11. The asphalt mixture of claim 10 further comprising a quantity of unmelted material, the quantity of the unmelted material is determined based on the combined quantity of the plastic material and the bio-based oil.

12. The asphalt mixture of claim 10 further comprising a quantity of a compatibilizer that is mixed with the mixed heated plastic and bio-based oil to provide a melted plastic, bio-based oil and compatibilizer mixture, the quantity of compatibilizer based on the combined quantity of the plastic material and bio-based oil.

13. The asphalt mixture of claim 12 further comprising a quantity of unmelted material, the quantity of the unmelted material is determined based on the combined quantity of the plastic material, the bio-based oil and the compatibilizer.

14. The additive of claim 10 further comprising a quantity of ground tire rubber that is heated and mixed with the bio-based oil and the plastic material to provide a melted plastic, bio-based oil and ground tire rubber mixture, the quantity of ground tire rubber is determined based on the combined quantity of the plastic material and bio-based oil.

15. The asphalt mixture of claim 14 further comprising a quantity of unmelted material, the quantity of the unmelted material is determined based on the combined quantity of the plastic material, the bio-based oil and the ground tire rubber.

16. The asphalt mixture of claim 10 further comprising:
a quantity of ground tire rubber that is heated and mixed with the bio-based oil and the plastic material to provide a melted plastic, bio-based oil and ground tire rubber mixture, the quantity of ground tire rubber is determined based on the combined quantity of the plastic material and bio-based oil; and
a quantity of a compatibilizer that is mixed with the mixed heated plastic, bio-based oil and ground tire rubber to provide a melted plastic, bio-based oil and compatibilizer mixture, the quantity of compatibilizer based on the combined quantity of the plastic material and bio-based oil.

17. The asphalt mixture of claim 16 further comprising a quantity of unmelted material, the quantity of the unmelted material is determined based on the combined quantity of the plastic material, the bio-based oil, the ground tire rubber and the compatibilizer.

18. The asphalt mixture of claim 10, wherein the melted plastic and bio-based oil mixture is solidified to provide the solidified composition that can be one of shredded into shredded pieces or pelletized into pellets or turned into a resin formation to provide one of:
a shredded softened plastic additive;
a pelletized softened plastic additive; and
a resin softened plastic additive.

19. A softened plastic additive, said additive comprising:
a melted plastic and bio-based oil mixture comprising:
a predetermined quantity of a plastic material; and
a quantity of a bio-based oil that is heated and mixed with the plastic material to provide a melted plastic and bio-based oil mixture, the quantity of the bio-based oil is determined based on the predetermined quantity of the plastic material, wherein the melted plastic and bio-based oil mixture is solidified to provide the solidified composition that can be one of:
shredded into shredded pieces to provide a shredded softened plastic additive;
pelletized into pellets to provide a pelletized softened plastic additive; and
turned into a resin formation to provide a resin softened plastic additive; and
a quantity of unmelted material that is added to the one of the shredded softened plastic additive, the pelletized softened plastic additive or the resin softened plastic additive, wherein the quantity of the unmelted material is determined based on the combined quantity of the plastic material and the bio-based oil.

20. The additive of claim 19 wherein the melted plastic and bio-based oil mixture further comprises at least one of:
a quantity of ground tire rubber that is heated and mixed with the bio-based oil and the plastic material to provide a melted plastic, bio-based oil and ground tire rubber mixture, the quantity of ground tire rubber is determined based on the combined quantity of the plastic material and bio-based oil; and
a quantity of a compatibilizer that is one of:
mixed with the mixed heated plastic and bio-based oil to provide a melted plastic, bio-based oil and compatibilizer mixture, the quantity of compatibilizer based on the combined quantity of the plastic material and bio-based oil; and
mixed with the mixed heated plastic, bio-based oil and ground tire rubber to provide a melted plastic, ground tire rubber, bio-based oil and compatibilizer mixture, the quantity of compatibilizer based on the combined quantity of the plastic material, ground tire rubber and bio-based oil.
